(19) United States
(12) Patent Application Publication
(10) Pub. No.: US 2005/0129416 A1
(43) Pub. Date: Jun. 16, 2005

(54) Image-forming device to protect a paper feeder using a switch and method thereof

(76) Inventor: Sun-jin Kim, Suwon-si (KR)

Correspondence Address: STANZIONE & KIM, LLP, 1740 N STREET, N.W., FIRST FLOOR, WASHINGTON, DC, 20036, US

(21) Appl. No.: 10/986,314

(22) Filed: Nov. 12, 2004

(30) Foreign Application Priority Data
Dec. 13, 2003 (KR) 2003-90964

(51) Int. Cl. G03G 15/00

(52) U.S. Cl. 399/18

(57) ABSTRACT

An image-forming device and a method which can protect a paper feeder by intercepting a driving voltage supplied to the paper feeder and preventing a collision between constituent elements if the paper feeder is in an abnormal state. The image-forming device includes a loading unit in which printing papers are loaded, a motor to move the loading unit, a sensor module to detect a position of the loading unit and information about existence/non-existence of the printing papers in the loading unit, a motor control unit to move the printing papers to a predetermined feeding position by driving the motor if a feeding command is received, a driving voltage supply unit to supply a driving voltage required for driving the motor to the motor control unit, and a switch to intercept a transfer of the driving voltage to the motor control unit if the loading unit moves over a predetermined range of position and becomes in contact with the switch.

### CROSS-REFERENCE TO RELATED APPLICATIONS

This application claims benefit from Korean Patent Application No. 2003-90964, filed on Dec. 13, 2003, the entire content of which is incorporated herein by reference.

### BACKGROUND OF THE INVENTION

1. Field of the Invention

The present general inventive concept relates to an image-forming device to protect a paper feeder using a switch and a method thereof, and more particularly, to an image-forming device and a method which can protect a paper feeder by mechanically intercepting a power supply to the paper feeder using a switch when the image-forming device malfunctions.

2. Description of the Related Art

Recently, with the spread and popularization of a computer, its peripheral devices have also been popularized. Such peripheral devices may be image-forming devices, such as printers, scanners, multifunctional devices, etc.

The structure of an image-forming device may be briefly divided into a controller part and an engine part. The controller part analyzes and stores image data transmitted from a computer in a RAM of a printer, communicates with the engine part so that the engine part can perform a printing operation, and then transmits the data stored in the RAM in a form of serial data.

The engine part includes an organic photo conductive drum, a laser scanning unit (LSU), a developer, a cleaning unit, a charge unit, a transfer unit, a fusing unit and so on. If the image data to be printed is received, the engine part performs the printing operation by performing processes of cleaning, charging, laser-scanning, writing, developing, transferring, fusing, etc., using such constituent elements.

Further, the engine part includes a feeder having a feeding cabinet (or feeding cassette), a pickup roller, and a driving motor for driving the pickup roller. If a printing command is inputted through the computer, the engine part supplies printing papers through a feeding unit and performs the above-described printing process, so that a desired document can be printed on the printing paper.

The image-forming devices recently used are mostly high-speed printers and digital multifunctional devices which typically adopt a large-capacity feeder which loads more than 500 printing papers. A feeding cassette of the large-capacity feeder adopts a technology that serves to lift up a paper loading unit using a motor so that printing papers are located in a feeding position if the printing papers are loaded on the loading unit. In this case, several sensors are required in order to accurately move the printing papers to the feeding position.

FIG. 1 is a block diagram illustrating a conventional image-forming device. Referring to FIG. 1, the conventional image-forming device includes a control unit 10, a feeder 20 and a display unit 30. The feeder 20 includes a motor control unit 21, a driving voltage supply unit 23, a feeding cassette 25, and a sensor module 27.

The control unit 10, if a printing command is inputted from an external device, properly controls respective constituent elements of an engine part and supplies printing papers to the engine part by inputting a feeding command to the feeder 20 to perform a printing operation.

The feeding cassette 25 is a part that contains the printing papers, and includes a loading unit loaded with the printing papers and a motor for lifting the loading unit. If the feeding command is inputted, the motor control unit 21 lifts the loading unit up to a predetermined position (hereinafter, referred to as a “feeding position”) by driving the motor in the feeding cassette 25.

The driving voltage supply unit 23 is a part which serves to supply a driving voltage of a predetermined level that is required by the motor control unit 21 to drive the motor of the feeding cassette 25.

The sensor module 27 includes a sensor for sensing and confirming whether the feeding cassette is properly mounted on the image-forming device, a sensor for sensing and confirming whether the printing paper properly reaches the feeding position through a movement of the loading unit, and a sensor for sensing and confirming whether the printing papers exist in the feeding cassette 25, so that the control unit 10 can properly control the motor control unit 21.

If it is sensed by the sensor module 27 that the feeding cassette 25 is not properly mounted on the printing device, or the printing papers are insufficient, the control unit 10 outputs an error message for indicating a present state of the engine part through the display unit 30, so that a user can be informed of the present state and take a proper step.

Meanwhile, in order to perform a large-capacity printing operation, the printing papers should continuously be fed. In this case, if the position of the printing paper escapes from the feeding position due to the reduction of the printing papers in the feeding cassette 25 as the printing operation is performed, this is sensed through the sensor module 27, and the loading unit is properly lifted up, so that the printing work can continuously be done.

FIG. 2 is a flowchart illustrating an image-forming method of the conventional image-forming device of FIG. 1. Referring to FIGS. 1 and 2, if the image-forming device receives the printing command (operation S81), the control unit judges through the sensor module 27 whether the feeding cassette 25 is properly mounted (operation S82) and whether the printing papers exist in the feeding cassette 25 (operation S83). If the feeding cassette is not properly mounted or no printing paper exists in the feeding cassette, the control unit outputs the corresponding error message to display the present state (operation S86).

If the feeding cassette 25 is properly mounted and the printing papers exist in the feeding cassette, the control unit lifts up the loading unit using the motor so that the printing papers are located in the feeding position (operation S84). If the printing papers are located in the feeding position (operation S85), the control unit performs the printing operation (operation S87).

That is, the control unit transfers the printing paper inside the feeding cassette using a pickup roller (operation S87a), and prints a desired document on the transferred printing paper through a specified printing process (operation S87b).

Then, it is checked whether the printing operation is completed (operation S88). If so, the control unit operates to terminate the printing operation and to display the present state. Meanwhile, if the position of the printing paper escapes from the feeding position due to the reduction of the printing papers in the feeding cassette 25 as the printing operation is performed, the control unit confirms the position of the printing paper through the sensor module 27, and controls the loading unit to continuously adjust the position of the printing papers (operation S89).

According to the above conventional image-forming device and method, if the position of the printing papers is not accurately sensed due to an abnormal operation of the sensor module 27, or if the motor is not stopped due to an abnormal operation of the motor control unit 21, the loading unit in which the printing papers are loaded may continuously move in a direction of the feeding position.

This may cause the loading unit to collide with another feeder to bring a mechanical damage, and cause an overload of the motor in the feeding cassette 25 to cause a fire.

### SUMMARY OF THE INVENTION

In order to solve the foregoing and/or other problems, it is an aspect of the present general inventive concept to provide an image-forming device and a method which can protect a paper feeder by intercepting a driving voltage to the paper feeder using a switch if the feeder is in an abnormal state.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an image-forming device which includes a motor to move a loading unit in which printing papers are loaded, a motor control unit to move the printing papers to a predetermined feeding position by driving the motor if a feeding command is received, a driving voltage supply unit to supply a driving voltage required for driving the motor to the motor control unit, and a switch to connect the driving voltage supply unit with the motor control unit to transfer the driving voltage from the driving voltage supply unit to the motor control unit, and to intercept the transfer of the driving voltage to the motor control unit if the loading unit moves over a predetermined range of a position thereof and becomes in contact with the switch.

In an aspect of the present general inventive concept, the image-forming device may further include a feeding cassette detection sensor to detect whether a feeding cassette provided with the loading unit and the motor is mounted on the image-forming device, a printing paper detection sensor to detect whether the printing papers are loaded in the loading unit, and a paper position detection sensor to detect whether the printing papers are located in the feeding position.

In another aspect of the present general inventive concept, the image-forming device may further include a power sensing unit to detect whether the driving voltage being supplied to the motor control unit is intercepted, a display unit to display predetermined messages on a screen, and a control unit to transmit the feeding command to the motor control unit if an external printing command is received, and to control the display unit to display an error message if it is detected that the driving voltage is intercepted.

In yet another aspect of the present general inventive concept, the switch may include a switch lever to extend over the feeding position on a moving path of the loading unit, and a switch contact to electrically connect the motor control unit with the driving voltage supply unit if the switch lever is connected to the switch contact, and to be physically disconnected from the switch lever if any one of the loading unit and the printing paper loaded in the loading unit comes into contact with the switch lever.

The foregoing and/or other aspects of the present general inventive concept may also be achieved by providing an image-forming method of an image-forming device having a loading unit loaded with printing papers and a motor to move the loading unit, the method including applying a driving voltage to the motor if a feeding command is received, moving the loading unit using the motor so that the printing papers reach a feeding position, performing a printing operation by feeding the printing papers, and stopping the motor by physically intercepting the driving voltage if the loading unit moves over a predetermined range of a position thereof.

In an aspect of the present general inventive concept, the image-forming method may further include judging whether the printing papers remain in the loading unit, and displaying a message to request a supplement of the printing papers.

In another aspect of the present general inventive concept, the image-forming method may further include detecting whether the driving voltage being supplied to the motor is intercepted, and displaying a predetermined error message if the driving voltage is intercepted.

In yet another aspect of the present general inventive concept that the applying of the driving voltage to the motor may include transferring the driving voltage to the motor through a switch lever extending over the feeding position on a moving path of the loading unit, and a switch contact connected to the switch lever.

In still another aspect of the present general inventive concept, the stopping of the motor may include disconnecting the switch contact from the switch lever by making any one of the loading unit and the printing paper loaded in the loading unit come into contact with the switch lever if the loading unit moves over the predetermined range of position.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a conventional image-forming device;

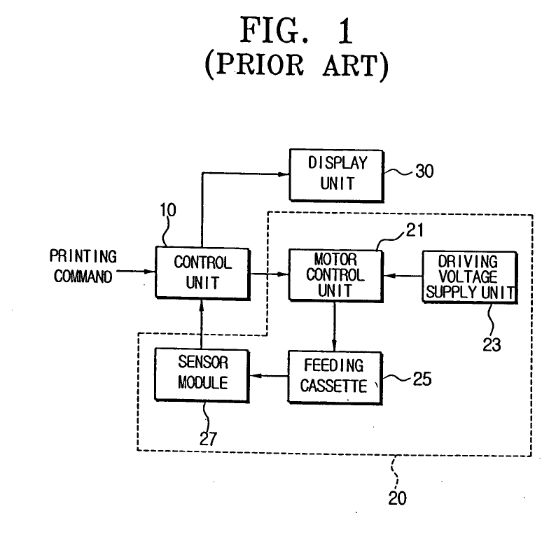

FIG. 2 is a flowchart illustrating an image-forming method using the conventional image-forming device of FIG. 1;

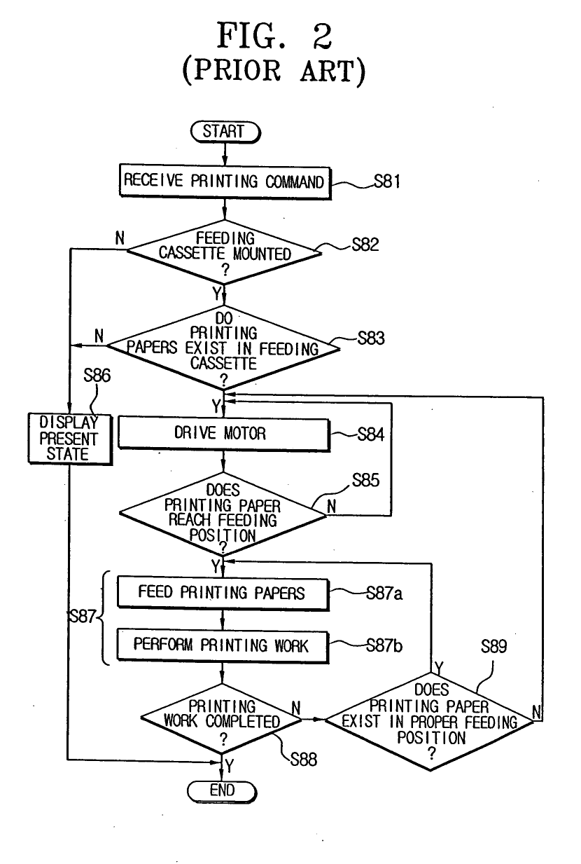

FIG. 3 is a block diagram illustrating an image-forming device according to an embodiment of the present general inventive concept;

FIG. 4 is a flowchart illustrating an image-forming method of an image-forming device according to another embodiment of the present general inventive concept; and

FIG. 5A-5D are graphs illustrating operation states of respective constituent elements of the image-forming device of FIG. 3; and

FIG. 6 is a view illustrating a switch of the image-forming device of FIG. 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

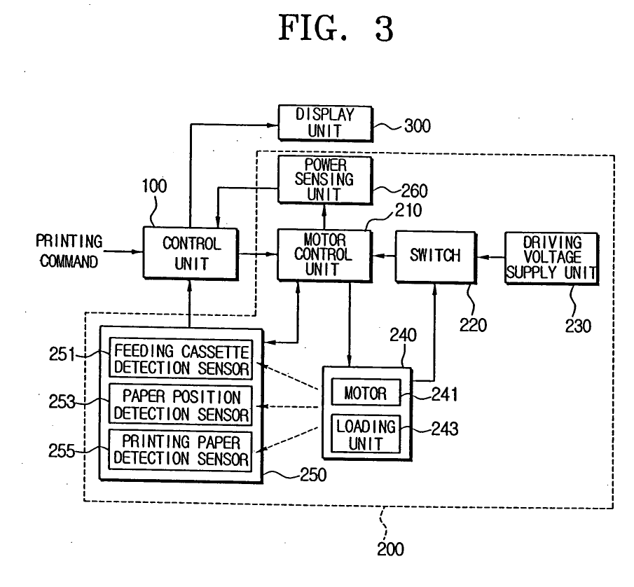

FIG. 3 is a block diagram illustrating an image-forming device according to an embodiment of the present general inventive, concept.

Referring to FIG. 3, the image-forming device may include a control unit 100, a feeder 200 and a display unit 300. The control unit 100 can properly control respective constituent elements (not illustrated) of a controller part upon receiving an external printing command and an engine part, and can transfer a feeding command to the feeder 200.

The feeder 200 can include a motor control unit 210, a switch 220, a driving voltage supply unit 230, a feeding cassette 240, a sensor module 250, and a power sensing unit 260.

The feeding cassette 240 may be a cabinet that contains printing papers. Typically, the feeding cassette 240 can have a volume enough to contain about 250 to 500 printing papers, and various kinds of feeding cassettes can be provided in accordance with different sizes of the printing papers. The feeding cassette 240 can be generally provided with a loading unit 243 directly loaded with the printing papers and a motor 241 to transfer the printing papers to a feeding position by moving the loading unit 243.

The motor control unit 210 can move the loading unit 243 by driving the motor 241 of the feeding cassette 240 upon receiving the feeding command from the control unit 100, so that the printing papers move to the feeding position. A driving voltage to drive the motor 241 can be supplied through the driving voltage supply unit 230.

Meanwhile, in order to accurately move the printing paper to the feeding position, the sensor module 250 should perform an accurate position detection. As shown in FIG. 3, the sensor module 250 can include a feeding cassette detection sensor 251, a paper position detection sensor 253 and a printing paper detection sensor 255. The feeding cassette detection sensor 251 can detect whether the feeding cassette 240 is properly mounted on the image-forming device. If the feeding cassette 240 is not properly mounted on the image-forming device, the feeding cassette detection sensor 251 can inform the control unit 100 that the feeding is impossible, and the control unit 100 can inform a user of this information through the display unit 300.

The paper position detection sensor 253 can serve to detect a position of an uppermost printing paper loaded in the loading unit 243. The position information sensed by the paper position detection sensor 253 can be inputted to the motor control unit 210, and the motor control unit 210 can drive the motor 241 based on the inputted position information so that the printing papers are accurately located in a feeding position by moving the loading unit 243. By continuously confirming the position of the printing paper during a printing operation, the motor control unit 210 can control the driving of the motor 241 so that the printing papers can be successively provided even if the number of the printing papers is reduced as the printing operation is performed.

Meanwhile, the printing paper detection sensor 255 can determine whether the printing papers exist on the loading unit 243, and if no printing paper exists, the printing paper detection sensor 255 can inform the control unit 100 of this information, so that the control unit 100 controls the display unit 300 to display the non-existence of the printing paper.

If the paper position detection sensor 253 or the motor control unit 210 malfunctions and thus the driving of the motor 241 in the feeding cassette 240 is not stopped, the loading unit 243 may continue to move and collide with any constituent element in the feeder 200, such as a pickup roller.

In this embodiment of the present general inventive concept, a switch 220 can be installed on a moving path of the loading unit 243, and if the loading unit 243 moves over a predetermined position, the switch 200 is actuated to intercept the driving voltage being supplied to the motor 241 and thus to stop the motor 241. As shown in FIG. 3, in a normal operation state, the switch 220 serves to connect the driving voltage supply unit 230 with the motor control unit 210 and to transfer the driving voltage to the motor control unit 210 to drive the motor 241.

In an aspect of the present general inventive concept, the switch 220 can be a mechanical switch having a switch lever and a switch contact connected thereto. The switch lever can be installed in a proper position on the moving path of the loading unit, and if the loading unit 243 moves over the predetermined position, the loading unit 243 collides with the switch lever. If the loading unit 243 can collide with the switch lever, the switch lever can physically be disconnected from the switch contact, and the driving voltage being supplied to the motor 241 to move the loading unit 243 can be intercepted. Accordingly, the motor 241 can be stopped, and this causes the loading unit 243 not to move further.

The interception of the driving voltage as described above may be implemented by using a semiconductor switch or sensor. In this case, however, the semiconductor switch or sensor may cause the loading unit to malfunction. In an aspect of the present general inventive concept the mechanical switch can be adapted, so that the supply of the driving voltage to the motor can physically intercepted.

If the switch 220 is turned off due to the collision with the loading unit 243 or the printing paper, and the driving voltage being supplied to the motor driving unit 210 is intercepted, the power sensing unit 260 can detect and report this collision or interception to the control unit 100.

The control unit 100, which has received this report on the collision or interception, can determine that an error has occurred in the feeder 200, and can generate a predetermined error message to report the error occurrence on the display unit 300. The user may consider a plan to fix the error of the image-forming device after viewing the error message displayed on the display unit 300.

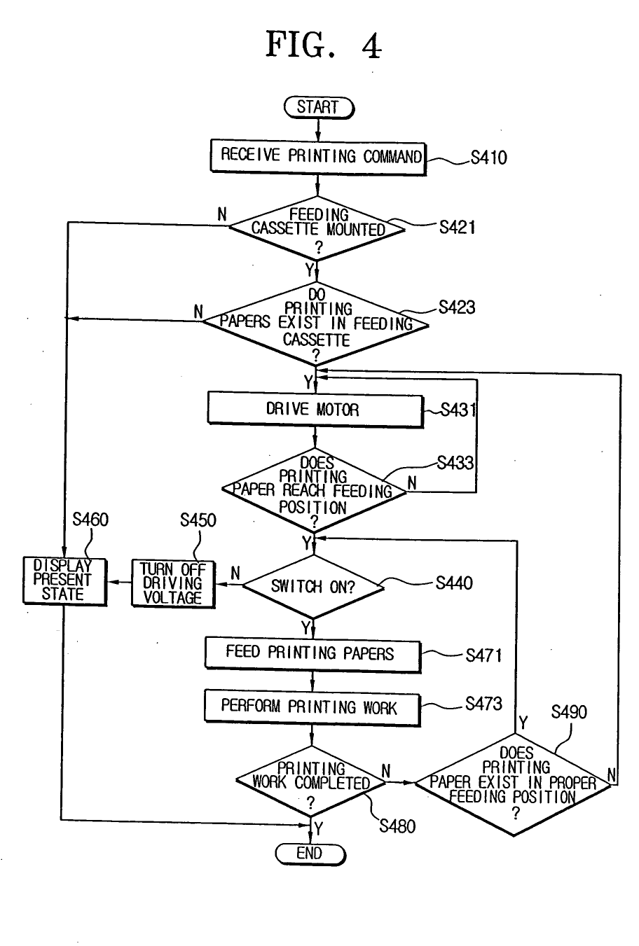

Hereinafter, an image-forming method according to another embodiment of the present general inventive concept will be explained with reference to FIG. 4.

Referring to FIGS. 3 and 4, if the printing command is received (operation S410), the control unit 100 can send the feeding command to the motor control unit 210. If the feeding command is received, the sensor module 250 can detect whether a feeding operation can be performed. Specifically, the sensor module 250 can detect whether the feeding cassette 240 is mounted using the feeding cassette detection sensor 251 (operation S421), and then detects whether printing papers remain in the feeding cassette 240 (operation S423). This printing paper detecting operation may be performed later. Meanwhile, if there is any trouble for the feeding cassette or the feeding papers, it is displayed through the display unit 300 (operation S460).

If it is detected that the printing papers remain in the feeding cassette 240, the motor control unit 210 can drive the motor 241 in the feeding cassette 240 to lift up the loading unit 243 (operation S431). This lifting operation continues until the printing paper reaches a proper feeding position, and if it is judged that the printing paper reaches the feeding position, the motor control unit 210 can stop the motor 241 (operation S433).

In the above process, if the loading unit 243 moves over the feeding position and collides with the switch lever of the switch 220, the driving voltage supply unit 230 can be disconnected from the motor control unit 210, and thus the driving voltage being supplied to the motor 241 can be intercepted (operations S440 and 450).

If the motor 241 is stopped by the interception of the driving voltage, the power sensing unit 260 can detect and inform the control unit 100 of this interception of the driving voltage, and the control unit 100 can display the error message through the display unit 300 (operation S460).

Meanwhile, if the motor 241 is normally driven without any collision with the switch lever and the printing paper reaches the feeding position, the feeding of the printing paper can be performed (operation S471). Specifically, a paper pickup roller can pick up and transfer the printing papers to a registration roller, and the registration roller arranges and moves the printing papers to a fusing roller in synchronization with image data inputted from the controller part.

Then, the printing operation can be performed together with the feeding operation (operation S473). Specifically, as the printing paper moves, the processes of cleaning, charging, laser-scanning, writing, developing, transferring, fusing, etc., can be successively performed.

Meanwhile, in a case of a successive printing operation (operation S480), the paper position detection sensor 253 can determine whether the printing papers are in the proper feeding position by continuously detecting the position of the printing papers, and can control the motor 241 to perform a successive feeding operation (operation S490).

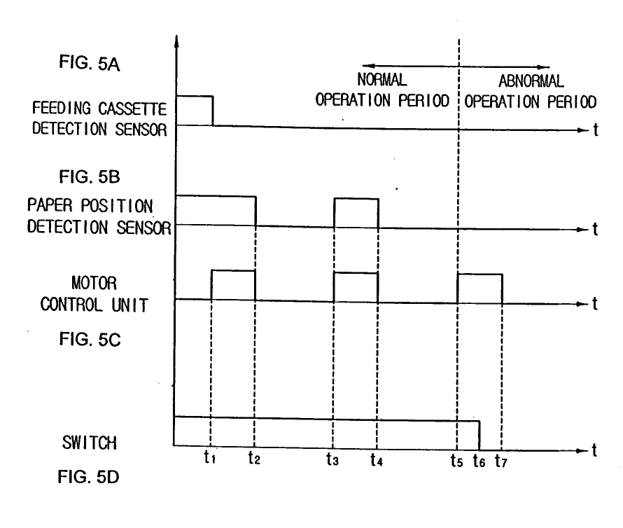

FIGS. 5A-5D are graphs illustrating operation states of respective constituent elements of the image-forming device of FIG. 3.

FIG. 5A shows the operation state of the feeding cassette detection sensor 251. It can be seen from FIG. 5A that the feeding cassette detection sensor 251 can detect the feeding cassette mounted on the image-forming device at a time point t1, and can output a detection signal at the time point t1. FIG. 5B shows a waveform of an output voltage of the paper position detection sensor 253. It can be seen from FIG. 5B that the printing paper can reach the feeding position at a time point t2. In the case of the successive printing operation, the paper position detection sensor 253 can detect that the printing paper escapes from the feeding position during a period of t3˜t4 due to a reduction of the printing papers, and output a detection signal.

FIG. 5C shows a waveform of an output voltage of the motor control unit 210. It can be seen from FIG. 5(c) that the motor control unit 210 can lift up the loading unit 243 by driving the motor 241 during a period of t1˜t2 since it is detected that the feeding cassette 240 is properly mounted at the time point t1 and the printing paper does not reach the feeding position until the time point t2. After the time point t2 when it is detected that the printing paper reaches the feeding position, the motor control unit 210 can prevent the driving voltage from being supplied to the motor 241 to fix the loading unit 243.

In this case, as shown in FIG. 5C, the motor control unit 210 can output again the motor driving voltage during periods of t3˜t4 and t5˜t7. Referring to FIG. 5B, in the period of t3˜t4, the printing paper escapes from the feeding position, and this refers to a normal operation period of the motor control unit 210. However, in the period of t5˜t7, the motor can be driven even though no detection signal is outputted, and this period of t5-t7 refers to an abnormal operation period of the motor control unit 210. This abnormal operation of the motor control unit 210 may cause a collision between the constituent elements of the image-forming device.

FIG. 5D shows the operation state of the switch to prevent the collision. It can be seen from FIG. 5D that until the time point t5, the feeder 200 can perform a normal operation, and the driving voltage supply unit 230 and the motor control unit 210 can be connected to each other through the switch 220. However, from the time point t5, the feeder 200 can perform the abnormal operation, and the motor 241 can continuously be driven during the period of t5˜t7. In this case, even if the loading unit 243 moves over the feeding position, it can collide with the switch lever at the time point t6, which is before the time point t7, and this causes the switch lever to be disconnected from the switch contact. Accordingly, after the time point t6, the supply of the driving voltage can be intercepted, and thus the motor can be stopped. As a result, the damage of the internal elements of the image-forming device can be prevented even if the error occurs in the feeder 200.

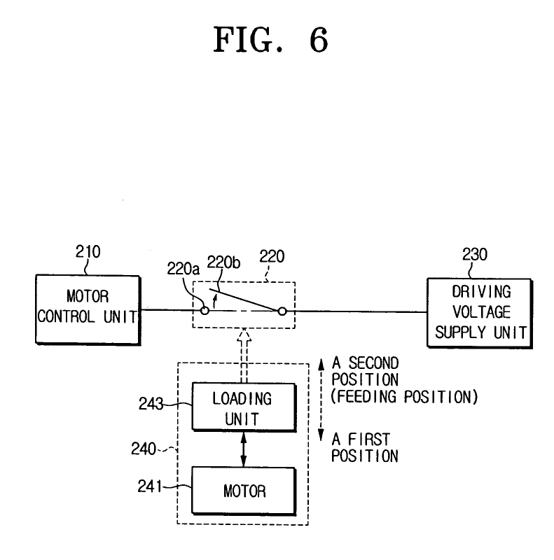

FIG. 6 is a view illustrating the switch 220 of the image-forming device of FIG. 3. Referring to FIG. 6, a switch contact 220a can be connected between the motor control unit 210 and the driving voltage supply unit 230 and can be turned on and off to selectively supply the driving voltage from the driving voltage supply unit 230 to the motor control unit 210. A switch lever 220b selectively contacts the loading unit 243 moving from a first position to a second position (feeding position) so that the switch contact 220a is turned on and off, thereby selectively supplying the driving voltage from the driving voltage supply unit 230 to the motor control unit 210.

As described above, according to an aspect of the present general inventive concept, even if a motor to feed printing papers becomes uncontrollable due to an abnormal operation of a motor control unit or a sensor module, and a printing paper or a loading unit in which printing papers are loaded is continuously lifted, a collision between constituent elements of an image-forming device or an overload of the motor can be prevented by mechanically intercepting a motor driving voltage being supplied to the motor. Such a switch can be implemented by a simple switch lever and contacts, and can operate without a trouble even if an error occurs in electronic circuits.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An image-forming device comprising:
a loading unit to contain printing papers;
a motor to move the loading unit in which the printing papers are loaded;
a motor control unit to move the printing papers to a predetermined feeding position by driving the motor if a feeding command is received;
a driving voltage supply unit to supply a driving voltage required for driving the motor to the motor control unit; and
a switch to connect the driving voltage supply unit with the motor control unit to transfer the driving voltage from the driving voltage supply unit to the motor control unit, and to intercept the transfer of the driving voltage to the motor control unit if the loading unit moves over a predetermined range of a position thereof and becomes in contact with the switch.

2. The image-forming device as claimed in claim 1, further comprising:
a feeding cassette having the loading unit and the motor;
a feeding cassette detection sensor to detect whether the feeding cassette is mounted on the image-forming device;
a printing paper detection sensor to detect whether the printing papers are loaded in the loading unit; and
a paper position detection sensor to detect whether the printing papers are located in the feeding position.

3. The image-forming device as claimed in claim 1, further comprising:
a power sensing unit to detect whether the driving voltage being supplied to the motor control unit is intercepted;
a display unit to detect a predetermined message on a screen; and
a control unit to transmit the feeding command to the motor control unit if an external printing command is received, and to control the display unit to display an error message if it is detected that the driving voltage is intercepted.

4. The image-forming device as claimed in claim 1, wherein the switch comprises:
a switch lever to extend over the feeding position on a moving path of the loading unit; and
a switch contact to electrically connect the motor control unit with the driving voltage supply unit if the switch lever is connected to the switch contact, and to be physically disconnected from the switch lever if any one of the loading unit and the printing paper loaded in the loading unit comes into contact with the switch lever.

5. An image-forming method of an image-forming device having a loading unit in which a printing paper is loaded, and a motor to move the loading unit, the image-forming method comprising:
applying a driving voltage to the motor if a feeding command is received;
moving the loading unit using the motor so that the printing paper is disposed in a feeding position;
performing a printing operation by feeding the printing paper; and
stopping the motor by physically intercepting the driving voltage supplied to the motor if the loading unit moves over a predetermined range of a position thereof.

6. The image-forming method as claimed in claim 5, further comprising:
judging whether the printing paper remains in the loading unit; and
displaying a message to request a supplement of the printing paper.

7. The image-forming method as claimed in claim 6, further comprising:
detecting whether the driving voltage being supplied to the motor is intercepted; and
displaying a predetermined error message if the driving voltage is intercepted.

8. The image-forming method as claimed in claim 7, wherein the applying of the driving voltage to the motor comprises transferring the driving voltage to the motor through a switch, and the switch comprises a switch lever to extend over the feeding position on a moving path of the loading unit and a switch contact connected to the switch lever.

9. The image-forming method as claimed in claim 8, wherein the transferring of the driving voltage to the motor through the switch comprises disconnecting the switch contact from the switch lever by making one of the loading unit and the printing paper loaded in the loading unit come into contact with the switch lever if the loading unit moves over the predetermined range of a position thereof so that the driving voltage is prevented from being supplied to the motor.

10. An image-forming device comprising:
a feeding cassette to contain a printing paper;
a motor control unit to control the feeding cassette to move the printing paper to a feeding position;
a driving voltage supply unit to supply a driving voltage to the motor control unit; and
a switch connected between the motor control unit and the driving voltage supply unit to selectively supply the driving voltage from the driving voltage supply unit to the motor control unit according to a movement of the feeding cassette.

11. The image-forming device as claimed in claim 10, wherein the switch is selectively connected the driving voltage supply unit and the motor control unit according to a contact between the switch and the feeding cassette.

12. The image-forming device as claimed in claim 10, wherein the switch comprises a mechanical switch.

13. The image-forming device as claimed in claim 10, wherein the driving voltage is supplied from the driving voltage supply unit and the motor control unit through the switch while a physical contact between the switch and the feeding cassette does not happen.

14. The image-forming device as claimed in claim 10, wherein the switch is turned off when the feeding cassette is disposed in an area outside a predetermined area, so that the driving voltage is prevented from being supplied from the driving voltage control unit to the motor control unit.

15. The image-forming device as claimed in claim 10, wherein the feeding cassette comprises:
a loading unit to accommodate the printing paper; and
a motor to move the loading unit so that the printing paper is disposed in the printing paper.

16. The image-forming device as claimed in claim 15, wherein the switch comprises a switch lever disposed on a moving path of the loading unit, and a switch contact to selectively connected between the driving voltage supply unit and the motor control unit according to a contact between the switch lever and the loading unit.

17. The image-forming device as claimed in claim 15, wherein the switch disconnect the driving voltage supply unit and the motor control unit according to a movement of the loading unit.

18. The image-forming device as claimed in claim 15, wherein the loading unit moves within an area between a first position and a second position, and the switch is selectively connected to the driving voltage supply unit and the motor control unit according to a movement of the loading unit.

19. The image-forming device as claimed in claim 18, wherein the switch is turned off not to supply the driving voltage from the driving voltage control unit to the motor control unit when the loading unit moves to a second area other than the area between the first and second positions.

20. The image-forming device as claimed in claim 18, wherein the switch is disposed on a position to contact the loading unit which is located on a second area other than the area between the first and second positions, so that the switch is turned off to prevent the driving voltage from being supplied from the driving voltage control unit to the motor control unit.

21. The image-forming device as claimed in claim 15, wherein the switch is disposed on a moving path of the loading unit to disconnect the driving voltage supply unit and the motor control unit according to a physically contact between the switch and the loading unit.

22. The image-forming device as claimed in claim 15, wherein the motor control unit controls the motor upon receiving the driving voltage from the driving voltage supply unit through the switch.

23. The image-forming device as claimed in claim 15, further comprising:
a control unit to generate an error message when the switch is disconnected between the driving voltage supply unit and the motor control unit according to a movement of the loading unit.

24. The image-forming device as claimed in claim 23, further comprising:
a display unit to display an image corresponding to the error message.

25. The image-forming device as claimed in claim 10, further comprising:
a sensor to detect a state of the switch and to generate a detecting signal; and
a control unit to generate an error message according to the detecting signal of the sensor.

26. The image-forming device as claimed in claim 25, wherein the sensor generates the detecting signal when the motor control unit is not supplied with the driving voltage from the driving voltage supply unit due to a disconnection between the motor control unit and the driving voltage supply unit.

27. The image-forming device as claimed in claim 25, wherein the sensor generates the detecting signal when the switch collides with a portion of the feeding cassette.

28. The image-forming device as claimed in claim 25, further comprising:
another sensor to detect when the printing paper is in the feeding position, and to generate a second detecting signal,
wherein the control unit generates the error message according to the second detecting signal of the another sensor.

29. The image-forming device as claimed in claim 10, further comprising:
a pick up roller to pick up the printing paper disposed in the feeding position so that a printing operation is performed on the picked-up printing paper.

30. An image-forming method of an image-forming device, the method comprising:
a feeding cassette to contain a printing paper:
controlling a feeding cassette to move a printing paper contained in a feeding cassette to a feeding position by supplying a driving voltage from a driving voltage control unit to a motor control unit through a switch; and
selectively turning on and off the switch to prevent the supply of the driving voltage from the driving voltage control unit to the motor control unit according to a movement of the feeding cassette.
